(19) United States
(12) Patent Application Publication
(10) Pub. No.: US 2026/0264887 A1
(43) Pub. Date: Sep. 10, 2026

(54) VEHICLE THAT CONVERTS HEAT FROM ATMOSPHERIC REENTRY ENVIRONMENT INTO ENERGY FOR POWERING REACTION CONTROL SYSTEM, AND RELATED SYSTEM AND METHOD

(71) Applicant: STOKE Space Technologies, Inc., Kent, WA (US)

(72) Inventors: Thomas Ryan McCullough, Seattle, WA (US); Patrick Ryan Ball, Seattle, WA (US); Matthew Michael Dethlefsen, Normandy Park, WA (US); Andrew Lapsa, Kent, WA (US); Thomas Feldman, Kent, WA (US); Justin Kayvon Bahrami, Bellevue, WA (US)

(21) Appl. No.: 19/450,588

(22) Filed: Jan. 15, 2026

Related U.S. Application Data
(63) Continuation of application No. PCT/US2024/055143, filed on Nov. 8, 2024.
(60) Provisional application No. 63/597,222, filed on Nov. 8, 2023.

(51) Int. Cl. B64G 1/26; B64G 1/24; B64G 1/40; B64G 1/58; B64G 1/62

(52) U.S. Cl. CPC B64G 1/26; B64G 1/244; B64G 1/402; B64G 1/58; B64G 1/62

(57) ABSTRACT

An atmospheric reentry vehicle includes a heat shield, a heat exchanger, and a reaction control system. The heat shield is configured to define a windward side of the vehicle during travel in an atmospheric reentry phase of a flight trajectory. The heat exchanger is disposed relative to the heat shield and has a coolant therein. The heat exchanger is configured to transfer energy from the heat shield to the coolant to generate a heated fluid flow. The reaction control system is configured to adjust an attitude of the vehicle using at least a portion of the heated fluid flow. Also disclosed is a multi-stage rocket system that includes the vehicle, and a related method for atmospheric reentry of the vehicle.

### CROSS-REFERENCE TO RELATED APPLICATION

This application claims priority to U.S. Provisional Patent Application No. 63/597,222, filed on Nov. 8, 2023, the contents of which are incorporated by reference herein in their entirety.

### TECHNICAL FIELD

The present disclosure generally relates to a vehicle that is subjected to high levels of heating. The present disclosure more particularly relates to a vehicle that converts heat from a high Mach number flow environment (e.g., an atmospheric reentry environment) into energy to power one or more onboard components, and a related system and method.

### BACKGROUND

Aircraft-like reusability for rockets has long been the “holy grail” of rocketry due to the potential for huge cost benefits. Reusing the upper stage of a multi-stage rocket is challenging due to the harsh reentry environment and the performance penalties associated with increased structural mass required for robust reuse. Reusing an upper stage rocket therefore requires significant additional functionality but with minimal mass addition.

Providing an atmospheric reentry vehicle that is capable of returning payloads from orbit also presents significant technical challenges. Such a vehicle would need to capture and store a downmass payload during in-space operations, and then survive the harsh reentry environment while carrying the downmass payload, which may have unknown or unpredictable mass characteristics. The downmass payload may shift the center of gravity of the vehicle and induce undesirable and/or unpredictable moments on the vehicle. This may prevent the vehicle from reentering the atmosphere at an ideal trim angle of attack, which can cause the high enthalpy flow encountered during atmospheric reentry to impinge on outer surfaces of the vehicle that lack adequate heat shielding. Such impingement of the high enthalpy flow on unshielded surfaces of the vehicle can have catastrophic consequences. Additionally or alternatively, reentering the atmosphere at a non-ideal trim angle of attack can result in reduced cross-range capability due to undesirable lift-to-drag ratio characteristics. This in turn can lead to increased uncertainty with respect to the landing zone of the vehicle.

Aspects of the present invention are directed to these and other problems.

### SUMMARY

According to an aspect of the present invention, a vehicle includes a heat shield, a heat exchanger, and a reaction control system. The heat shield is configured to define a windward side of the vehicle during travel in an atmospheric reentry phase of a flight trajectory. The heat exchanger is disposed relative to the heat shield and has a coolant therein. The heat exchanger is configured to transfer energy from the heat shield to the coolant to generate a heated fluid flow. The reaction control system is configured to adjust an attitude of the vehicle using at least a portion of the heated fluid flow.

According to another aspect of the present invention, a multi-stage rocket system includes a lower stage rocket and an upper stage rocket separable from the lower stage rocket. The upper stage rocket includes a heat shield, a heat exchanger, and a reaction control system. The heat shield is configured to define a windward side of the upper stage rocket during travel in an atmospheric reentry phase of a flight trajectory. The heat exchanger is disposed relative to the heat shield and has a coolant therein. The heat exchanger is configured to transfer energy from the heat shield to the coolant to generate a heated fluid flow. The reaction control system is configured to adjust an attitude of the upper stage rocket using at least a portion of the heated fluid flow.

According to another aspect of the present invention, a method for atmospheric reentry of a vehicle includes the steps of: operating the vehicle in space, the vehicle including a heat shield and a heat exchanger disposed relative to the heat shield; and maneuvering the vehicle such that the vehicle commences an atmospheric reentry phase of a flight trajectory. During travel in the atmospheric reentry phase of the flight trajectory, the method further includes the steps of: maintaining the vehicle in an orientation in which the heat shield defines a windward side of the vehicle; actively cooling the heat shield by transferring energy from the heat shield to a coolant in the heat exchanger to generate a heated fluid flow; and controlling an attitude of the vehicle using at least a portion of the heated fluid flow.

In addition to, or as an alternative to, one or more of the features described above, further aspects of the present invention can include one or more of the following features, individually or in combination:
the vehicle or upper stage rocket includes a nose, a base opposite the nose, a sidewall extending in a direction between the nose and the base, a propulsion engine at the base, the heat shield is at the base, and the reaction control system is at the sidewall;
the reaction control system includes at least a first attitude control thruster at a first sidewall position and a second attitude control thruster at a second sidewall position;
the reaction control system includes a plurality of attitude control thrusters, and each of the plurality of attitude control thrusters is recessed into the sidewall of the vehicle or upper stage rocket;
the vehicle or upper stage rocket includes a flow controller configured to receive the heated fluid flow from the heat exchanger and control flow of at least the portion of the heated fluid flow to the reaction control system;
the flow controller is a multi-port valve;
the flow controller includes a plurality of discrete valves;
the vehicle or upper stage rocket includes a heated fluid conduit that fluidly connects the flow controller to the reaction control system, the heated fluid conduit configured to receive at least the portion of the heated fluid flow;
the vehicle or upper stage rocket includes the flow controller is transitionable between a first state and a second state, and in the first state, the flow controller is configured such that a flow path between the heat exchanger and the heated fluid conduit is closed, and in the second state, the flow controller is configured such that the flow path between the heat exchanger and the heated fluid conduit is open;
the vehicle or upper stage rocket includes a propulsion engine having a combustion chamber, and a combustion chamber conduit that fluidly connects the flow controller to the combustion chamber of the propulsion engine;
the flow controller is configured such that, in both the first state and the second state, a flow path between the heat exchanger and the combustion chamber conduit is open;
the flow controller is configured such that, when the flow controller is in the first state, a flow path between the heat exchanger and the combustion chamber conduit is open, and when the flow controller is in the second state, the flow path between the heat exchanger and the combustion chamber conduit is closed;
the vehicle or upper stage rocket includes a flight controller configured to transition the flow controller between the first state and the second state at predetermined times during a flight trajectory of the vehicle or upper stage rocket;
the flight controller is configured to transition the flow controller from the first state to the second state during a first predetermined period after an ascent phase of the flight trajectory and before an atmospheric reentry phase of the flight trajectory;
the flight controller is configured to transition the flow controller from the second state back to the first state during a second predetermined period after the atmospheric reentry phase of the flight trajectory and before a landing phase of the flight trajectory;
the propulsion engine includes the combustion chamber and a nozzle, the propulsion engine is transitionable between an on mode and an off mode, and in the on mode of the propulsion engine, a second portion of the heated fluid flow and an oxidizer flow are combusted in the combustion chamber and a resulting combustion gas flow is exhausted through the nozzle, and in the off mode of the propulsion engine, no combustion occurs within the combustion chamber;
the flight controller is further configured to transition the propulsion engine between the on mode and the off mode, and the flight controller is configured to maintain the flow controller in the first state when the propulsion engine is in the on mode, and maintain the flow controller in the second state when the propulsion engine is in the off mode;
the second portion of the heated fluid flow is received in the combustion chamber via a combustion chamber conduit that fluidly connects the combustion chamber to the flow controller;
in the off mode of the propulsion engine, the second portion of the heated fluid flow is received in the combustion chamber and is exhausted through the nozzle without being combusted;
the vehicle is an upper stage rocket of a multi-stage rocket system;
the vehicle or upper stage rocket includes at least one attitude control thruster, the step of controlling the attitude includes exhausting at least the portion of the heated fluid flow through the at least one attitude control thruster to generate a thrust that induces a moment on the vehicle or upper stage rocket;
the vehicle or upper stage rocket includes a plurality of attitude control thrusters, the step of controlling the attitude includes exhausting at least the portion of the heated fluid flow through the plurality of attitude control thrusters to generate a thrust that induces a moment on the vehicle or upper stage rocket;
the vehicle or upper stage rocket includes a plurality of attitude control thrusters, a first attitude control thruster of the plurality of attitude control thrusters generates a first thrust having a first thrust direction and a first thrust magnitude, a second attitude control thruster of the plurality of attitude control thrusters generates a second thrust having a second thrust direction and a second thrust magnitude, the first thrust magnitude is different that the second thrust magnitude, and the first thrust direction is different than the second thrust magnitude;
the vehicle or upper stage rocket is configured to naturally adopt a baseline trim angle of attack when the vehicle or upper stage rocket has a baseline center of gravity and is travelling in a ballistic trajectory, and the step of controlling the attitude includes using at least the portion of the heated fluid flow to orient the vehicle or upper stage rocket at a biased trim angle of attack, a magnitude of the biased trim angle of attack is different than a magnitude of the baseline trim angle of attack;
the magnitude of the baseline trim angle varies as a function of the velocity of the vehicle or upper stage rocket;
the vehicle or upper stage rocket has a first lift-to-drag ratio when oriented at the baseline trim angle of attack and a second lift-to-drag ratio when oriented at the biased trim angle of attack, and the second lift-to-drag ratio is different than the first lift-to-drag ratio;
the atmospheric reentry phase of the flight trajectory includes a high heat period during which a velocity of the vehicle or upper stage rocket is above a threshold velocity, and a low heat period during which the velocity of the vehicle or upper stage rocket is below the threshold velocity, the step of controlling the attitude includes using at least the portion of the heated fluid flow to maintain the orientation of the vehicle or upper stage rocket at the biased trim angle of attack during an entirety of the high heat portion of the atmospheric reentry phase;
the velocity threshold is in a range between Mach 4 and Mach 30;
the vehicle or upper stage rocket is configured to naturally adopt a baseline trim angle of attack when the vehicle or upper stage rocket has a baseline center of gravity and is travelling in a ballistic trajectory, the atmospheric reentry phase of the flight trajectory includes a high heat period during which a velocity of the vehicle or upper stage rocket is above a threshold velocity, and a low heat period during which the velocity of the vehicle or upper stage rocket is below the threshold velocity, the step of controlling the attitude of the vehicle or upper stage rocket includes using at least the portion of the heated fluid flow to orient the vehicle or upper stage rocket at a first biased trim angle of attack during travel in the high heat period of the atmospheric reentry phase, and using at least the portion of the heated fluid flow to orient the vehicle or upper stage rocket at a second biased trim angle of attack during travel in the low heat period of the atmospheric reentry phase, a magnitude of the first biased trim angle of attack is different than a magnitude of the second biased trim angle of attack;
the vehicle is configured to naturally adopt a baseline trim angle of attack when the vehicle has a baseline center of gravity and is travelling in a ballistic trajectory, and during travel in the atmospheric reentry phase of the flight trajectory, the vehicle or upper stage rocket has an actual center of gravity that is offset relative to a baseline center of gravity of the vehicle or upper stage rocket, which induces a first moment on the vehicle or upper stage rocket, and the step of controlling the attitude of the vehicle or upper stage rocket includes exhausting at least the portion of the heated fluid flow from the vehicle or upper stage rocket to generate a thrust that induces a second moment on the vehicle or upper stage rocket, and the second moment at least partially counteracts the first moment;
the vehicle is configured to naturally adopt a baseline trim angle of attack when the vehicle has a baseline center of gravity and is travelling in a ballistic trajectory, and during travel in the atmospheric reentry phase of the flight trajectory, the vehicle or upper stage rocket has an offset center of gravity and is configured to naturally adopt an offset trim angle of attack when travelling in the ballistic trajectory, and a magnitude of the offset trim angle of attack is different than a magnitude of the baseline trim angle of attack, and the step of controlling the attitude of the vehicle or upper stage rocket includes using at least the portion of the heated fluid flow to orient the vehicle or upper stage rocket at a biased trim angle of attack, and a magnitude of the biased trim angle of attack is different than the magnitude of the offset trim angle of attack;
a magnitude of heat flux through the heat shield is directly correlated to a velocity of the vehicle or upper stage rocket, and the portion of the heated fluid flow has an available impulse that is directly correlated to the magnitude of the heat flux, the step of controlling an attitude using at least the portion of the heated fluid flow is performed only when the available impulse thereof is sufficient to overcome aerodynamic forces acting on the vehicle or upper stage rocket;
the portion of the heated fluid flow is a first bypass portion of the heated fluid flow, the method further includes, during travel in the atmospheric reentry phase of the flight trajectory, reducing a magnitude of heat flux through the heat shield using a second bypass portion of the heated fluid flow;
the vehicle or upper stage rocket includes a propulsion engine at least partially recessed into the heat shield, and the propulsion engine includes a combustion chamber and a nozzle, and the step of reducing heat flux on the heat shield involves receiving the second bypass portion of the heated fluid flow in the combustion chamber and exhausting the second bypass portion of the heated fluid flow through the nozzle;
the step of reducing heat flux on the heat shield involves exhausting the second bypass portion of the heated fluid flow through the nozzle to push a bow shock away from the vehicle or upper stage rocket;
the vehicle or upper stage rocket includes a nose, a base opposite the nose, and a propulsion engine at the base and at least partially recessed into the heat shield, the propulsion engine including a combustion chamber and a nozzle, the step of reducing heat flux on the heat shield involves receiving the second bypass portion of the heated fluid flow in the combustion chamber and exhausting the second bypass portion of the heated fluid flow through the nozzle;
the step of reducing heat flux on the heat shield involves exhausting the second bypass portion of the heated fluid flow through the nozzle to at least one of: (i) cause separation of a high enthalpy flow from the base of the vehicle or upper stage rocket; (ii) cause separation of a high enthalpy flow from an outer surface of the vehicle or upper stage rocket; and (iii) provide a cooling film on the outer surface;
the propulsion engine is transitionable between an on mode and an off mode, and in the on mode of the propulsion engine, the second bypass portion of the heated fluid flow and an oxidizer flow are combusted in the combustion chamber and a resulting combustion gas flow is exhausted through the nozzle, and in the off mode of the propulsion engine, no combustion occurs within the combustion chamber, and the step of exhausting the second bypass portion of the heated fluid flow through the nozzle is performed when the propulsion engine is in the off mode;
the vehicle or upper stage rocket further includes a propulsion engine at least partially recessed into the heat shield, the propulsion engine includes a combustion chamber, a nozzle through which fluids initially exit the combustion chamber, a turbine configured to receive a primary portion of the heated fluid flow from the heat exchanger and output a turbine exhaust flow, and a turbine exhaust port configured to exhaust the turbine exhaust flow from the vehicle or upper stage rocket, and the method further includes, during travel in the atmospheric reentry phase of the flight trajectory, reducing a magnitude of heat flux through the heat shield by exhausting the turbine exhaust flow through the turbine exhaust port;
the step of reducing heat flux on the heat shield involves exhausting the turbine exhaust flow through the turbine exhaust port to at least one of: (i) push a bow shock away from the vehicle or upper stage rocket, (ii) cause separation of a high enthalpy flow from the base of the vehicle or upper stage rocket, and (iii) cause separation of a high enthalpy flow from an outer surface of the vehicle;
the propulsion engine is transitionable between an on mode and an off mode, and in the on mode of the propulsion engine, the second bypass portion of the heated fluid flow and an oxidizer flow are combusted in the combustion chamber and a resulting combustion gas flow is exhausted through the nozzle, and in the off mode of the propulsion engine, no combustion occurs within the combustion chamber, and the step of exhausting the turbine exhaust flow through the turbine exhaust port is performed when the propulsion engine is in the off mode; and
the method further includes, before the maneuvering step, separating the upper stage rocket from the at least one lower stage rocket.

These and other aspects of the present invention will become apparent in light of the drawings and detailed description provided below.

### BRIEF DESCRIPTION OF THE DRAWINGS

FIG. 1 is an elevation view of a two-stage rocket system including the present vehicle in the form of an upper stage rocket.

FIG. 2 is an exploded elevation view of the two-stage rocket system of FIG. 1.

FIG. 3 is a perspective view of the vehicle of FIG. 1.

FIG. 4 is a schematic elevation view of the vehicle of FIG. 1 in a zero angle of attack orientation.

FIG. 5 is a schematic elevation view of the vehicle of FIG. 1 in a non-zero angle of attack orientation.

FIG. 6 schematically illustrates a portion of the engine and nozzle of the vehicle of FIG. 1.

FIG. 7 is a schematic elevation view of the aft end of the vehicle of FIG. 1.

FIG. 8 is a schematic sectional view of the vehicle of FIG. 1 when the engine is in an on mode and the flow controller is in a first state.

FIG. 9 schematically illustrates components of the vehicle of FIG. 1 when the engine is in the on mode and the flow controller is in the first state.

FIG. 10 is a schematic sectional view of the vehicle of FIG. 1 when the engine is in an off mode and the flow controller is in a second state.

FIG. 11 schematically illustrates components of the vehicle of FIG. 1 when the engine is in the off mode and the flow controller is in the second state.

FIG. 12 schematically illustrates the flight trajectory of the two-stage rocket system of FIG. 1.

FIG. 13 illustrates steps of the present method for atmospheric reentry of the vehicle of FIG. 1.

FIG. 14 schematically illustrates the vehicle of FIG. 1 during operation of the reaction control system.

FIG. 15 is a non-dimensional plot illustrating a relationship between the trim angle of attack of the vehicle of FIG. 1 and the Mach number of the vehicle.

FIG. 16 schematically illustrates the vehicle of FIG. 1 during operation of the reaction control system.

FIG. 17 is a non-dimensional plot illustrating a relationship between heat flux through the heat shield and Mach number of the vehicle during atmospheric reentry of the vehicle of FIG. 1.

FIG. 18 is a non-dimensional plot illustrating a relationship between the available impulse of the heated fluid flow (measured in Newtons (N)) and the Mach number of the vehicle of FIG. 1 during atmospheric reentry (solid line), and a relationship between the impulse required by the reaction control system to overcome aerodynamic forces on the vehicle and the Mach number of the vehicle during atmospheric reentry (dashed line).

FIG. 19 schematically compares the atmospheric reentry of the vehicle of FIG. 1 during exhaustion of heated fluid flow through the base (left of centerline) with the atmospheric reentry of a similarly-shaped vehicle that does not exhaust a fluid flow through the base (right of centerline).

FIG. 20 further schematically compares the atmospheric reentry of the vehicle of FIG. 1 during exhaustion of heated fluid flow through the base (left of centerline) with the atmospheric reentry of a similarly-shaped vehicle that does not exhaust a fluid flow through the base (right of centerline).

### DETAILED DESCRIPTION

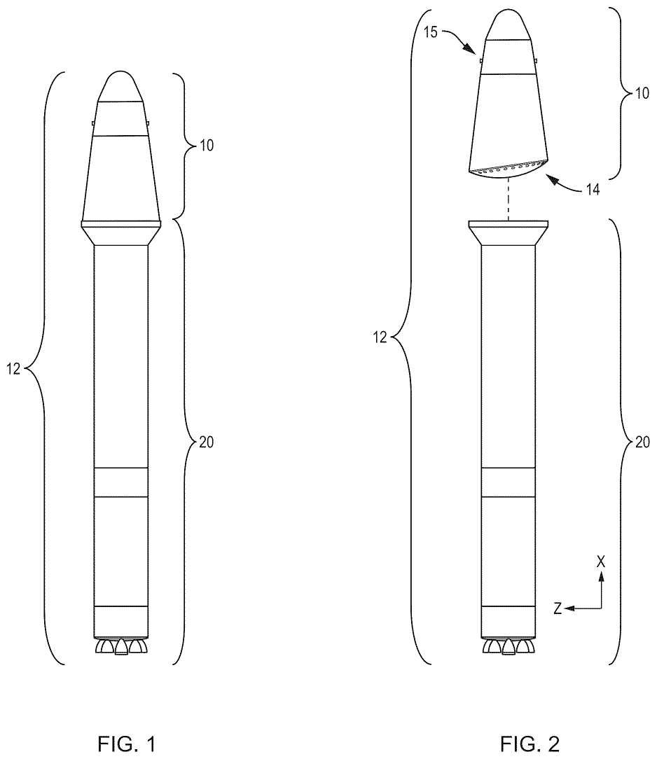

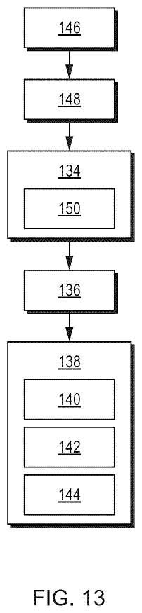

Referring to FIGS. 1-2, the present disclosure describes a vehicle 10 configured to travel in a high Mach number flow environment (e.g., an atmospheric reentry environment), a system 12 including the vehicle 10, and a related method (FIG. 13) for operating the vehicle 10.

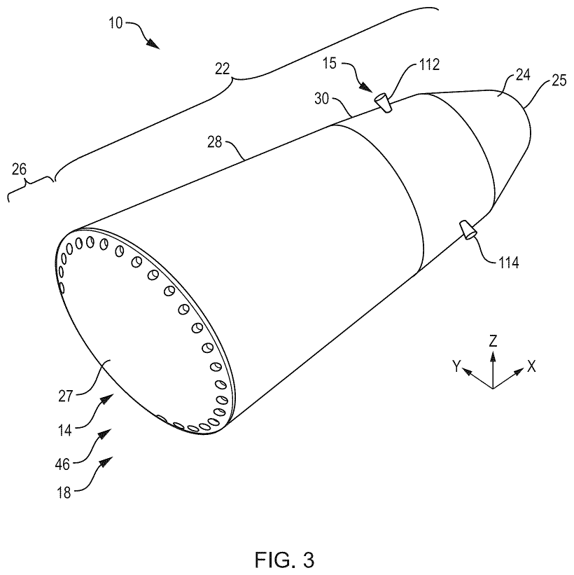

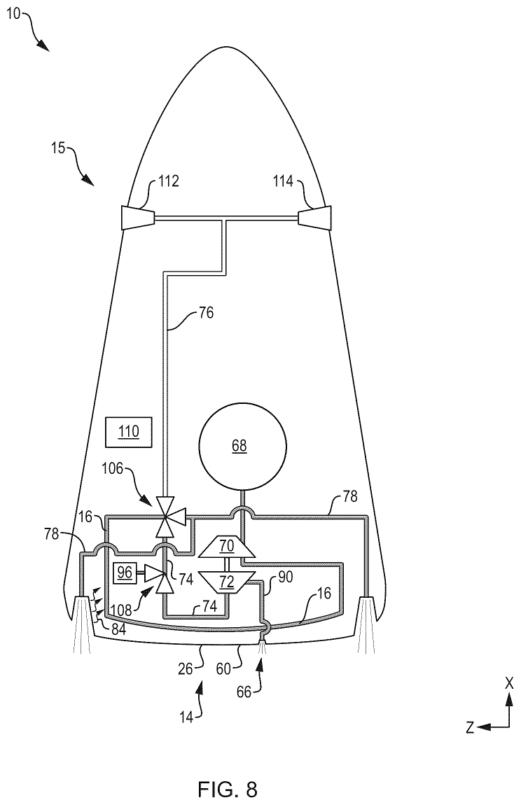

Referring to FIGS. 3-11, the vehicle 10 includes a heat shield 14, a heat exchanger 16 (FIGS. 8-11) disposed relative to the heat shield 14, and a reaction control system 15 (FIGS. 3-5 and 8-11). The heat shield 14 is configured to define a windward side of the vehicle 10 during travel in a high Mach number flow environment phase (hereinafter the “atmospheric reentry phase”) of a flight trajectory. The heat exchanger 16 is configured to transfer energy from the heat shield 14 to a coolant in the heat exchanger 16 to generate a heated fluid flow and thereby maintain the heat shield 14 below a melting temperature during travel in the atmospheric reentry phase of the flight trajectory. The reaction control system 15 is configured to adjust an attitude of the vehicle 10 using at least a portion (e.g., a bypass portion) of the heated fluid flow.

The vehicle 10 provides significant advantages over prior art atmospheric reentry vehicles. As will be discussed in more detail below, the reaction control system 15 is configured to use at least a portion of the heated fluid flow to re-trim or bias an angle of attack of the vehicle 10 during the atmospheric reentry phase of the flight trajectory. This can be done to correct for a non-ideal trim angle of attack that may occur in various situations, such as when the vehicle 10 has an unknown and/or offset center of gravity following the in-space capture and storage of a downmass payload. Moreover, in some embodiments, the vehicle 10 is also configured to use one or more portions of the heated fluid flow to power or pressurize another component or system onboard the vehicle 10. For example, in some embodiments, the vehicle 10 is configured to adjust an attitude of the vehicle 10 and/or reduce a heat flux through the windward side of the vehicle 10 using one or more other portions of the heated fluid flow. Notably, in some embodiments, the above-mentioned functionalities are achieved using at least one already-existing component of a propulsion engine 18 (e.g., a rocket engine) that is onboard the vehicle 10, and these functionalities can be achieved when the engine 18 is in an off mode. In other embodiments, these functionalities are achieved using components (e.g., one or more pumps, tanks, conduits, etc.) that are all separate from the components of the propulsion engine 18.

Referring to FIGS. 1-2, the vehicle 10 is a rocket (e.g., a multi-stage rocket, a single-stage-to-orbit (SSTO) rocket, an upper stage rocket, a booster rocket, etc.), a missile, a spacecraft, an aircraft, or another vehicle designed for travel (e.g., flight) up to at least supersonic speeds (e.g., supersonic speeds, hypersonic speeds, reentry speeds, etc.) in atmospheric, sub-orbital, orbital, extraterrestrial, and/or outer space environments. In some embodiments, the vehicle 10 is an upper stage rocket of a multi-stage rocket system 12 that also includes at least one lower stage rocket 20. In the illustrated embodiments, the vehicle 10 is a second stage rocket of a two-stage rocket system 12 that also includes a first stage rocket 20.

Referring to FIGS. 3-5, in the illustrated embodiment, the vehicle 10 includes a main body 22 defining a nose 24 at a forward end 25 of the vehicle 10, a base 26 at an aft end 27 of the vehicle 10, and a sidewall 28 extending in a direction between the nose 24 and the base 26. The main body 22 includes a payload housing 30. The heat shield 14 is at the base 26 and the aft end 27. The reaction control system 15 is at the sidewall 28. The vehicle 10 also includes a primary propulsion engine 18 that is at least partially recessed into the heat shield 14 and the base 26.

In some embodiments, the vehicle 10 has a non-axisymmetric shape that allows the vehicle 10 to generate lift when oriented at a zero angle of attack during atmospheric reentry, in a same or similar manner as disclosed in the commonly-assigned U.S. Provisional Patent Application No. 63/174,323 filed Apr. 13, 2021, U.S. Provisional Patent Application No. 63/236,002 filed Aug. 23, 2021, International Patent Application No. PCT/US 22/71686 filed Apr. 13, 2022, International Patent Application No. PCT/US 22/71688 filed Apr. 13, 2022, and U.S. Provisional Patent Application No. 63/518,790 filed Aug. 10, 2023, the contents of which are incorporated herein by reference in their entirety. In other embodiments not shown in the drawings, the vehicle 10 has an axisymmetric shape. For example, the axisymmetric shape of the vehicle 10 may be similar to that of the vehicle shown in U.S. Provisional Patent Application No. 62/941,386, filed on Nov. 27, 2019 and International Patent Application No. PCT/US 2020/048178 filed on Aug. 27, 2020, the contents of which are incorporated herein by reference in their entirety. In such embodiments, an entirety of the vehicle 10 is at least substantially axisymmetric relative to the centerline of the vehicle 10.

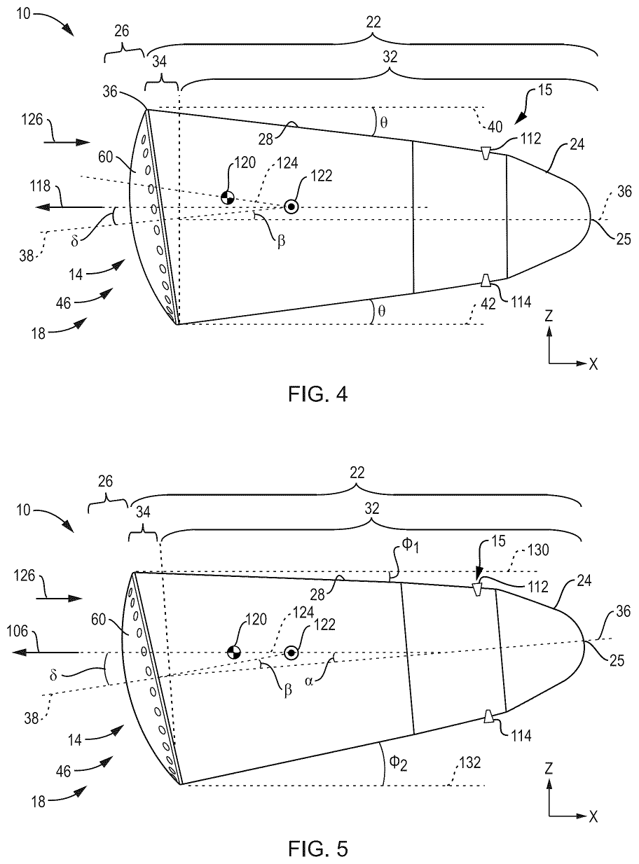

Referring to FIGS. 4-5, in the illustrated embodiment, the main body 22 includes an axisymmetric forward main body section 32 and a non-axisymmetric aft main body section 34. The forward main body section 32 is shaped such that the outer surface thereof is at least substantially axisymmetric relative to a main body centerline 36 (e.g., a linear centerline perpendicular to the tangent of the forwardmost point of the main body 22) extending in a direction between the forward end of the main body 22 and the opposing aft end of the main body 22. The aft main body section 34 is shaped such that the outer surface thereof is non-axisymmetric relative to the main body centerline 36. In the illustrated embodiment, the outer surface of the aft main body section 34 defines an oblique frustoconical shape. The base 26 of the vehicle 10 is shaped such that the outer surface thereof is at least substantially axisymmetric relative to a base centerline 38 (e.g., a linear centerline perpendicular to the tangent of the aftmost point of the base 26) extending in a direction between a forward end of the base 26 and the opposing aft end of the base 26. The vehicle 10 is therefore configured such that the base centerline 38 (also referred to herein as the “heat shield centerline 38”) is offset relative to the main body centerline 36 by an angle β. The sidewall 28 is disposed at an angle θ (hereinafter the “sidewall angle θ”) relative to planes 40, 42 parallel to the main body centerline 36.

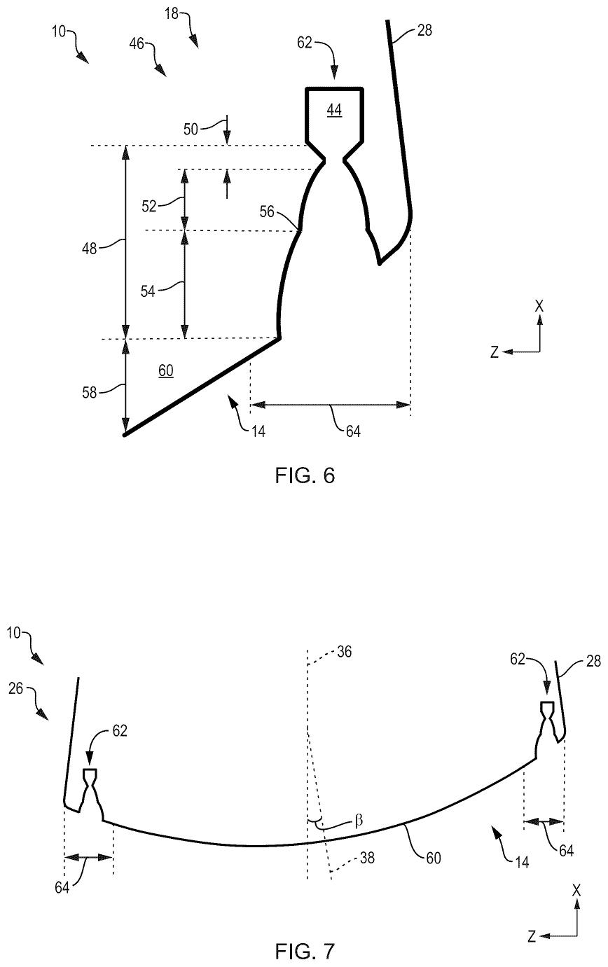

Referring to FIGS. 6 and 7, the engine 18 includes at least one high-pressure chamber 44 (hereinafter the “combustion chamber 44”) and at least one nozzle 46.

The combustion chamber 44 emits a fluid that is exhausted through the nozzle 46. The combustion chamber 44 is in the form of an annular ring, a segmented ring, individual chambers, or another configuration providing supersonic flow to the nozzle 46.

The nozzle 46 can be configured in a same or similar manner as those disclosed in commonly-assigned U.S. Provisional Patent Application No. 62,941,386, filed Nov. 27, 2019, U.S. Provisional Patent Application No. 62/942,886, filed Dec. 3, 2019, International Patent Application No. PCT/US 2020/048178 filed Aug. 27, 2020, International Patent Application No. PCT/US 2020/48226 filed Aug. 27, 2020 filed Aug. 27, 2020, U.S. Provisional Patent Application No. 63/174,323 filed Apr. 13, 2021, U.S. Provisional Patent Application No. 63/236,002 filed Aug. 23, 2021, International Patent Application No. PCT/US 22/71686 filed Apr. 13, 2022, International Patent Application No. PCT/US 22/71688 filed Apr. 13, 2022, U.S. Provisional Patent Application No. 63/518,790 filed Aug. 10, 2023, and International Patent Application No. PCT/US 24/41511 filed Aug. 8, 2024, the contents of which are incorporated herein by reference in their entirety.

Referring to FIG. 6, in the illustrated embodiment, the nozzle 46 includes an initial nozzle portion 48 through which exhaust gas initially exits the combustion chamber 44. The initial nozzle portion 48 is in the form of a dual-expansion nozzle and includes a throat 50, a first expansion section 52 downstream of the throat 50, a second expansion section 54 downstream of the first expansion section 52, and an inflection point 56 defined where the first expansion section meets the second expansion section 54. The nozzle 46 further includes a secondary nozzle portion 58 defined by a centerbody 60.

Referring to FIG. 7, the engine 18 has a so-called “plug cluster” configuration in which a plurality of discrete combustion chambers 44 are spaced relative to one another, and a plurality of discrete initial nozzle portions 48 are spaced relative to one another. Each initial nozzle portion 48 is located relative to a corresponding combustion chamber 44 and is configured to exhaust gas exiting the respective combustion chamber 44. Each combustion chamber 44 and initial nozzle portion 48 pair is referred to herein as a “thruster 62.” The thrusters 62 can be configured in a same or similar manner as those disclosed in the above-mentioned commonly-assigned patent applications. Moreover, the thrusters 62 can be positioned on the vehicle 10 and positioned relative to one another in a same or similar manner as those disclosed in the above-mentioned commonly-assigned patent applications.

The engine 18 is transitionable between an on mode and an off mode. In the illustrated embodiment, in the on mode of the engine 18, a fuel and an oxidizer are combusted in the combustion chamber 44 and a resulting combustion gas flow is exhausted through the nozzle 46. In the off mode of the engine 18, no combustion occurs within the combustion chamber 44.

Referring to FIG. 7, the base 26 of the vehicle 10 includes one or more components that define the heat shield 14 and the outer surface thereof (i.e., the “heat shield outer surface”). In the illustrated embodiment, the base 26 includes a centerbody 60 and a thruster mount 64, which each define portions of the heat shield 14 and the heat shield outer surface, and which collectively form a blunt body. In some embodiments, the components that form the heat shield outer surface are metallic (e.g., formed of a durable metallic material such as sheet metal), and the heat shield 14 may therefore be referred to as a durable metallic heat shield having a metallic heat shield outer surface. In the illustrated embodiment, the centerbody 60 and the thruster mount 64 are configured in a same or similar manner as those disclosed in the above-mentioned U.S. Provisional Patent Application No. 63/518,790 filed Aug. 10, 2023 and International Patent Application No. PCT/US 24/41511 filed Aug. 8, 2024. In some embodiments, the thruster mount 64 and/or the centerbody 60 of the base 26 include one or more turbine exhaust ports 66 (see FIGS. 8-11) through which turbine exhaust exits the vehicle 10. The number of turbine exhaust ports 66, the size of the turbine exhaust ports 66, and/or the positions of the turbine exhaust ports 66 can vary depending on the particular application. FIGS. 8-11 schematically depict one of a plurality of turbine exhaust ports 66 that are recessed into the heat shield 14 and the base 26 of the vehicle 10. In the illustrated embodiment, the turbine exhaust ports 66 are configured in a same or similar manner as the base bleed openings disclosed in the above-mentioned U.S. Provisional Patent Application No. 63/518,790 filed Aug. 10, 2023 and International Patent Application No. PCT/US 24/41511 filed Aug. 8, 2024.

The heat shield 14 and the heat exchanger 16 are part of a heat shield system that is at least similar to the heat shield system disclosed in the above-mentioned patent applications. During an atmospheric reentry phase of a flight trajectory, the heat shield system actively cools the heat shield 14 in a manner that will be described in more detail below. In some embodiments, at least a portion of the sidewall 28 of the vehicle 10, and/or another component of the vehicle 10, is actively cooled in a same or similar manner.

Referring to FIGS. 8-11, in the illustrated embodiment, the heat shield system further includes at least one tank 68, at least one pump 70, at least one turbine 72, at least one primary heated fluid conduit 74, at least one first bypass heated fluid conduit 76, and at least one second bypass heated fluid conduit 78.

The tank 68 is configured to store a coolant (e.g., an active coolant, a liquid coolant, a cryogenic coolant, etc.). In the illustrated embodiment, the tank 68 is a liquid hydrogen storage tank. The liquid hydrogen also functions as a fuel for the engine 18 during operation of the engine 18, as will be described in more detail below.

The pump 70 is configured to receive the coolant from the tank 68, and output a pressurized coolant (e.g., a coolant having a pressure of 1378 kPa or higher). That is, the pressure of the coolant is greater after it passes through the pump 70 than it is when stored in the tank 68. The coolant is transferred from the tank 68 to the pump 70 via a coolant conduit (e.g., ducting, tubing, etc.).

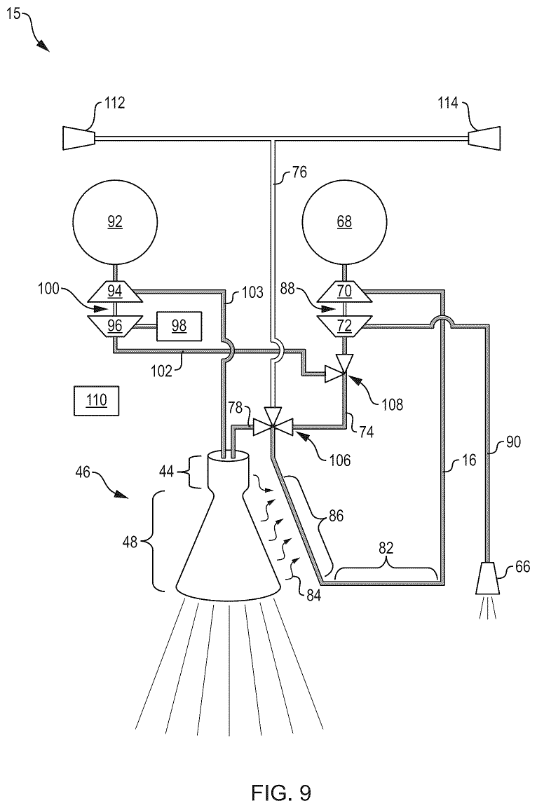

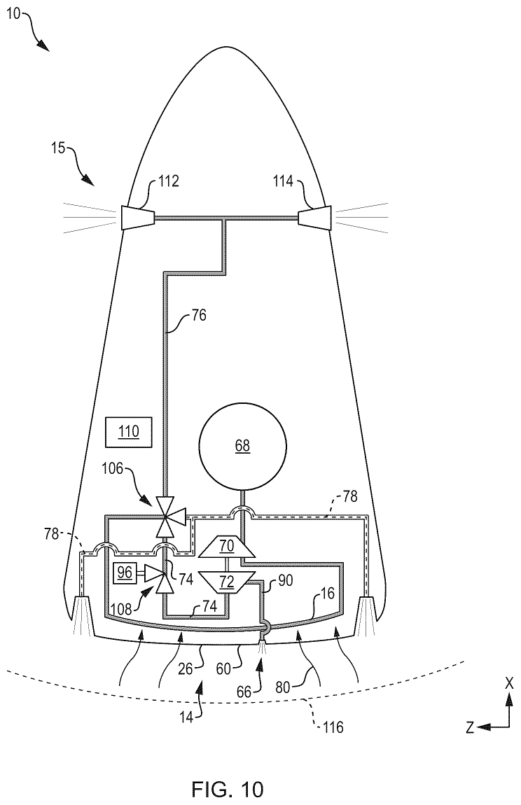

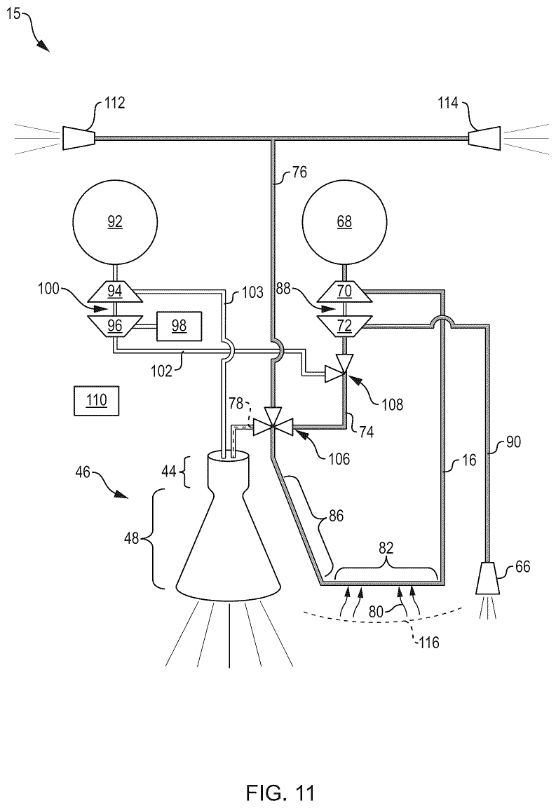

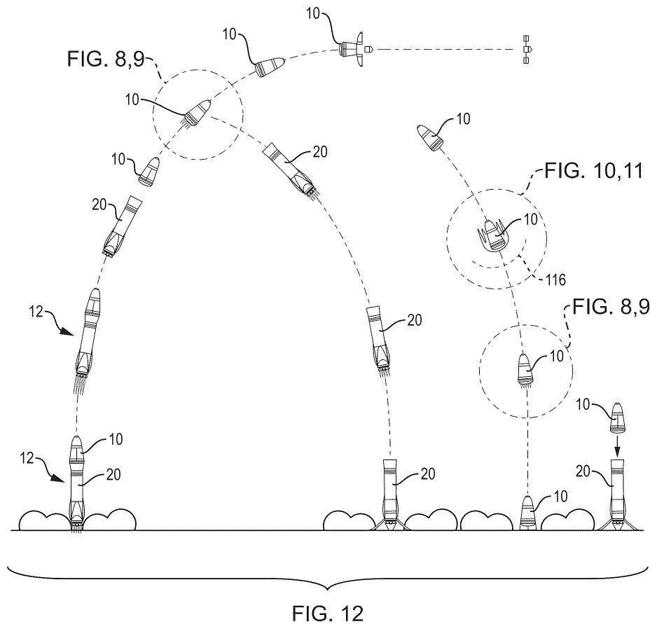

The heat exchanger 16 includes at least one heat exchanger conduit (e.g., ducting, tubing, etc.) configured to receive the pressurized coolant from the pump 70 and permit the pressurized coolant to flow therethrough. Referring to FIGS. 10 and 11, the heat exchanger 16 and the heat exchanger conduit are integrally connected with the heat shield 14 or are otherwise configured to transfer energy 80 (e.g., via heat flux) from the heat shield 14 to the pressurized coolant flowing in a heat shield segment 82 (FIG. 11) of the heat exchanger conduit to generate the heated fluid flow during the atmospheric reentry phase of the flight trajectory. The heat exchanger 16 and the heat exchanger conduit are also configured to transfer energy 84 (e.g., via heat flux) from one or more components of the engine 18 (e.g., the combustion chamber 44, the nozzle 46, etc.) to the pressurized coolant and/or the heated fluid flow in an engine segment 86 of the heat exchanger conduit during final ascent and propulsive landing phases of the flight trajectory (e.g., when the engine 18 is in the on mode) (FIGS. 8 and 9). The amount of energy transferred by the heat exchanger 16 and the heat exchanger conduit is sufficient to maintain components of the engine 18 and the heat shield 14 below their respective melting temperatures during operation of the vehicle 10 across the entire flight trajectory.

Referring to FIGS. 8-11, the turbine 72 includes a turbine inlet, a turbine shaft 88 (FIGS. 9 and 11), and a turbine outlet. The turbine inlet is configured to receive a primary portion of the heated fluid flow from the heat exchanger 16 via a primary heated fluid conduit 74 (e.g., ducting, tubing, etc.) that is configured to be fluidly connected with the heat exchanger conduit. The turbine shaft 88 is coupled (e.g., directly coupled, indirectly coupled via a coupler, etc.) to the pump 70 and includes turbine blades mounted thereon. The turbine shaft 88 rotates and thereby powers the pump 70 when the primary portion of the heated fluid flow received from the heat exchanger 16 acts on the turbine blades. The turbine outlet outputs the primary portion of the heated fluid flow to one or more turbine exhaust ports 66 (e.g., base bleed openings) at the base 26 of the vehicle 10. The turbine exhaust ports 66 are fluidly connected to the turbine outlet via one or more turbine exhaust conduits 90. In some embodiments, the heat shield system further includes bearings, gears, and/or seals (not shown) that facilitate the coupling of the turbine 72 and the pump 70 via the shaft 88. In other embodiments not shown in the drawings, the heat shield system excludes a pump and/or a turbine. In some such embodiments, the pressure of the coolant in the tank alone provides enough energy to deliver the coolant to the heat exchanger. In some embodiments, the heat shield system excludes a turbine and includes an electric pump.

Referring to FIGS. 9 and 11, in the illustrated embodiment, the engine 18 further includes an oxidizer tank 92, an oxidizer pump 94, an oxidizer turbine 96, and an oxidizer turbine exhaust port 98. The oxidizer turbine 96 includes an oxidizer turbine inlet, an oxidizer turbine shaft 100, and an oxidizer turbine outlet. The oxidizer turbine inlet is configured to receive a portion of the heated fluid flow from the heat exchanger 16 via a conduit 102 (e.g., ducting, tubing, etc.). The oxidizer turbine shaft 100 is coupled (e.g., directly coupled, indirectly coupled via a coupler, etc.) to the oxidizer pump 94 and includes turbine blades mounted thereon. The oxidizer turbine shaft 100 rotates and thereby powers the oxidizer pump 94 when the portion of the heated fluid flow acts on the turbine blades of the oxidizer turbine 96. The oxidizer pump 94, when powered by the oxidizer turbine 96, outputs an oxidizer to the combustion chamber 44 via a conduit 103. The oxidizer turbine outlet outputs the portion of the heated fluid flow to one or more oxidizer turbine exhaust ports 98 (e.g., base bleed openings located at the base 26 of the vehicle 10). In some embodiments, the heat shield system further includes bearings, gears, and/or seals (not shown) that facilitate the coupling of the oxidizer turbine 96 and the oxidizer pump 94 via the shaft 100.

During one or more phases of the flight trajectory, the energy transferred from the heat shield 14 to the coolant in the heat exchanger 16 will exceed the energy needed to drive the turbine shaft 88 and thereby power the pump 70. During at least these phases, the first bypass heated fluid conduit 76 is configured to receive a first bypass portion of the heated fluid flow from the heat exchanger 16. The reaction control system 15 is configured to receive the first bypass portion of the heated fluid flow from the first bypass heated fluid conduit 76, and is configured to exhaust the same from the vehicle 10 to generate a thrust that induces a moment on the vehicle 10. The reaction control system 15 is thereby configured to adjust and/or control an attitude of the vehicle 10, as will be described in more detail below.

In some embodiments, at least one component of the heat shield system is an already-existing component of the engine 18. In the illustrated embodiment, at least the tank 68, the pump 70, and the turbine 72 are already-existing components of the engine 18. The coolant stored in the tank 68 is the fuel of the engine 18. When the engine 18 is in an on mode (FIGS. 8 and 9), the coolant/fuel is delivered to the combustion chamber 44 of the engine 18 via the pump 70, the heat exchanger 16, and the second bypass heated fluid conduit 78 that fluidly connects the combustion chamber 44 to the heat exchanger 16. The second bypass heated fluid conduit 78 is sometimes referred to herein as the “combustion chamber conduit 78.” In other embodiments not shown in the drawings, the tank, the pump, the turbine, and/or one or more other components of the heat shield system are not components of the engine. In some such embodiments, the engine includes at least one tank, at least one pump, and/or at least one turbine that are discrete components separate from those of the heat shield system.

Referring to FIGS. 8-11, in some embodiments, the heat shield system further includes a flow controller 106 configured to control flow of the heated fluid flow to several conduits downstream of the heat exchanger 16. In the illustrated embodiment, the flow controller 106 includes at least one multi-port valve that is fluidly connected to a downstream end of the heat exchanger conduit. In other embodiments, the flow controller 106 includes a plurality of discrete valves that are fluidly connected to one another via one or more conduits (e.g., ducting, tubing, etc.).

In FIGS. 8-11, the various conduits are shown. A conduit with dark grey fill indicates the presence of fluid flow in the respective conduit. A conduit without the dark grey fill indicates the absence of fluid flow in the respective conduit. A conduit with a dashed line fill indicates that the presence of fluid flow in the respective conduit is optional in the illustrated state. For example, FIGS. 8 and 9 depict the first bypass heated fluid conduit 76 without the dark grey fill to indicate the absence of fluid flow therethrough, but FIGS. 10 and 11 depict the first bypass heated fluid conduit 76 with the dark grey fill to indicate the presence of fluid flow therethrough. Also, FIGS. 8 and 9 depict the combustion chamber conduit 78 and oxidizer conduits 102, 103 (FIG. 9) with the dark grey fill, but FIGS. 10 and 11 depict the combustion chamber conduit 78 as a dashed line and depict the oxidizer conduits 102, 103 (FIG. 11) without the dark grey fill.

In the illustrated embodiment, the flow controller 106 is transitionable between a first state (FIGS. 8-9) and a second state (FIGS. 10-11). In the first state (FIGS. 8-9), the flow controller 106 is configured such that a first flow path between the heat exchanger 16 and the primary heated fluid conduit 74 is open, and a second flow path between the heat exchanger 16 and the first bypass heated fluid conduit 76 is closed. In the second state (FIGS. 10-11), the flow controller 106 is configured such that the first flow path and the second flow path are both open.

In some embodiments, the flow controller 106 is configured such that, when the flow controller 106 is in the first state (FIGS. 8-9), a third flow path between the heat exchanger 16 and the combustion chamber conduit 78 is open, and when the flow controller 106 is in the second state (FIGS. 10-11), the third flow path is closed. In other embodiments, the flow controller 106 is configured such that, in both the first state (FIGS. 8-9) and the second state, a third flow path between the heat exchanger 16 and the combustion chamber conduit 78 is open.

Referring to FIGS. 9 and 11, in the illustrated embodiment, the vehicle 10 further includes an oxidizer flow controller 108 that is transitionable between a first state (FIG. 9) and a second state (FIG. 11). In the first state (FIG. 9), a flow path is open such the oxidizer turbine inlet receives a portion of the heated fluid flow from the heat exchanger 16, and the oxidizer turbine 96 drives the oxidizer pump 94 to deliver oxidizer from the oxidizer tank 92 to the combustion chamber 44 of the engine 18. In the second state (FIG. 11), the flow path is closed such that the oxidizer turbine inlet does not receive a portion of the heated fluid flow from the heat exchanger 16, and thus the oxidizer turbine 96 does not drive the oxidizer pump 94 to deliver oxidizer to the combustion chamber 44 of the engine 18. In the illustrated embodiment, the oxidizer flow controller 108 includes at least one multi-port valve. In other embodiments, the oxidizer flow controller 108 includes a plurality of discrete valves that are fluidly connected to one another via one or more conduits (e.g., ducting, tubing, etc.).

In the illustrated embodiment, the vehicle 10 further includes a flight controller 110 that is configured to transition the flow controller 106 and the oxidizer flow controller 108 between their respective first states (FIGS. 8-9) and their respective second states (FIGS. 10-11) at predetermined times during a flight trajectory of the vehicle 10. The flight controller 110 is configured to transition the flow controller 106 and the oxidizer flow controller 108 from their respective first states (FIGS. 8-9) to their respective second states (FIGS. 10-11) during a first predetermined period after an ascent phase of the flight trajectory (e.g., when the engine 18 is in the on mode) and before an atmospheric reentry phase of the flight trajectory (e.g., when the engine 18 is in the off mode). The flight controller 110 is further configured to transition the flow controller 106 and the oxidizer flow controller 108 from their respective second states (FIGS. 10-11) back to their respective first states (FIGS. 8-9) during a second predetermined period after the atmospheric reentry phase of the flight trajectory (e.g., when the engine 18 is in the off mode) and before a landing phase of the flight trajectory (e.g., when the engine 18 is in the on mode).

In some embodiments, the flight controller 110 is further configured to transition the engine 18 between the on mode and the off mode. In some such embodiments, the flight controller 110 is configured to maintain the flow controller 106 and the oxidizer flow controller 108 in their respective first states when the engine 18 is in the on mode (FIGS. 8-9), and is configured to maintain the flow controller 106 and the oxidizer flow controller 108 in their respective second states when the engine 18 is in the off mode (FIGS. 10-11).

As indicated above, in some embodiments the third flow path between the heat exchanger 16 and the combustion chamber conduit 78 is open in both the first and second states of the flow controller 106. In some such embodiments, when the engine 18 is in the off mode, a second bypass portion of the heated fluid flow is received in the combustion chamber 44 and is exhausted through the nozzle 46 without being combusted. As will be discussed in more detail below, this can be done to adjust an attitude of the vehicle 10 and/or reduce a heat flux through the windward side of the vehicle 10.

The functionality of the flight controller 110 can be implemented using analog and/or digital hardware (e.g., counters, switches, logic devices, memory devices, programmable processors, non-transitory computer-readable storage mediums), software, firmware, or a combination thereof. The flight controller 110 can communicate with the flow controller 106, the oxidizer flow controller 108, and/or one or more components of the engine 18 via wired or wireless connections, and can perform one or more of the functions described herein by executing software, which can be stored, for example, in a memory device. Although the flight controller 110 is described as being a discrete component, in some embodiments the flight controller 110, or one or more components thereof, can be combined into a single component with the flow controller 106, the oxidizer flow controller 108, and/or one or more components of the engine 18.

Referring to FIGS. 8-11, in the illustrated embodiment, the reaction control system 15 includes at least one attitude control thruster 112, 114 configured to receive the first bypass portion of the heated fluid flow via the first bypass heated fluid conduit 76. In some embodiments, the reaction control system 15 includes a plurality of attitude control thrusters 112, 114, each of which is recessed into the sidewall 28 of the vehicle 10. In some embodiments, each of the attitude control thrusters 112, 114 is a de Laval nozzle or another type of nozzle that is configured to exhaust an amount of the first bypass portion of the heated fluid flow from the vehicle 10 to generate a thrust that induces a moment on the vehicle 10. Referring to FIGS. 8 and 10, in the illustrated embodiment, the reaction control system 15 includes at least a first attitude control thruster 112 at a first position relative to the sidewall 28 and a second attitude control thruster 114 at a second position relative to the sidewall 28. The first attitude control thruster 112 is configured to exhaust a first amount of the first bypass portion of the heat fluid flow to generate a first thrust having a first thrust direction and a first thrust magnitude, and the second attitude control thruster 114 is configured to exhaust a second amount of the first bypass portion of the heated fluid flow to generate a second thrust having a second thrust direction and a second thrust magnitude. In some situations, the first thrust magnitude is different that the second thrust magnitude, and the first thrust direction is different than the second thrust magnitude. In some embodiments, the reaction control system 15 includes more than two (2) attitude control thrusters 112, 114 and one or more components (e.g., one or more controllable valves in fluid communication with the first bypass heated fluid conduit 76) for controlling the relative amounts of the first bypass portion of the heated fluid flow that are exhausted through the respective attitude control thrusters 112, 114. In some embodiments, the flight controller 110 is configured to control such components (e.g., configured to transition between closed and open states) for operating the reaction control system 15. In some embodiments, the reaction control system 15 is a primary reaction control system. In other embodiments, the reaction control system 15 is an auxiliary reaction control system that is provided in addition to a primary reaction control system of the vehicle.

Referring to FIG. 12, in the illustrated embodiments, the vehicle 10 can be operated in several different modes across different phases of a flight trajectory. During liftoff and initial ascent phases, the vehicle 10 is fixed to the forward end of a lower stage rocket 20 that propels the rocket system 12 toward a stage separation altitude. During the liftoff and initial ascent phases, the main body 22 (see FIG. 3) defines the windward side of the vehicle 10, and the engine 18 (see FIG. 3) of the vehicle 10 is not operational. When the rocket system 12 is at or near the stage separation altitude (e.g., between 60 km and 120 km from sea level), the vehicle 10 separates from the lower stage rocket 20 and begins a final ascent phase during which the engine 18 and nozzle 46 are operated (see FIGS. 8 and 9) to propel the vehicle 10 to a maximum mission altitude (e.g., above 100 km from sea level). The vehicle 10 then begins an atmospheric reentry phase during which the heat shield 14 and the base 26 defines the windward side of the vehicle 10. During the atmospheric reentry phase, operation of the engine 18 is paused and the heat shield 14 is actively cooled (see FIGS. 10 and 11) to protect the vehicle 10 from the harsh atmospheric reentry environment. The vehicle 10 descends in this manner until a terminal descent altitude (e.g., between 0.1 km and 4 km from seal level) is reached. Once the vehicle 10 reaches the terminal descent altitude, a propulsive landing phase begins during which the engine 18 is operated (see FIGS. 8 and 9) within the low altitude range to controllably land the vehicle 10 at a precise location where it can be retrieved and prepped for reuse.

During in-space and atmospheric reentry phases of the flight trajectory, the vehicle 10 moves through an environment (e.g., space, the atmosphere) at freestream Mach numbers that can approach Mach thirty (30). During the atmospheric reentry phase, a bow shock 116 is formed upstream of the vehicle 10, and the temperature on the vehicle side of the bow shock 116 (FIGS. 10-12) can reach thousands of degrees Kelvin. The bow shock 116 generates significant drag to reduce the velocity of the vehicle 10, and also generates significant aerodynamic heating on the heat shield 14, thereby necessitating cooling and/or other thermal protection for reusability, such as the above-mentioned active cooling system.

Referring again to FIG. 4, in the illustrated embodiment, the vehicle 10 may initially reenter the atmosphere at a so-called zero angle of attack (i.e., α=0°), in which the vehicle 10 is oriented such that the main body centerline 36 is parallel to the direction of travel 118. In this orientation (i.e., attitude), the heat shield centerline 38 is offset relative to the direction of travel 118 by an angle δ equal to the angle β at which the heat shield centerline 38 is offset relative to the main body centerline 36. In the zero angle of attack orientation, the baseline center of gravity 120 and the center of pressure 122 of the vehicle 10 are in a plane 124 offset relative to the direction of travel 118. The fact that the heat shield outer surface is skewed relative to the main body centerline 36 by an angle β advantageously causes a net lift force on the vehicle 10 relative to the direction of travel 118, even at the zero angle of attack. In the illustrated embodiment, the baseline center of gravity 120 is the center of gravity that the vehicle 10 is designed to possess when the vehicle 10 does not include a payload stored in the payload housing 30.

In the illustrated embodiment, during operation of the vehicle 10 at a zero angle of attack and a baseline center of gravity 120 (FIG. 4), the aerodynamic lift and drag forces on the vehicle 10 will generate pitching moments about the baseline center of gravity 120, and the vehicle 10 will naturally adopt an orientation at which those moments are balanced (i.e., the “aerodynamic trim point” or “trim angle of attack” or “baseline trim angle of attack”). This orientation, shown in FIG. 5, increases the angle of attack α between the main body centerline 36 and the high enthalpy flow 126 that is moving relative to the vehicle 10 in a direction opposite the direction of travel 118. The non-zero angle of attack orientation (FIG. 5) therefore generates more lift than the zero angle of attack orientation (FIG. 4). In the non-zero angle of attack (FIG. 5), the plane 128 of the baseline center of gravity 120 and the center of pressure 122 will be parallel relative to the direction of travel 118, and opposing sides of the vehicle 10 will be at different respective angles φ₁, φ₂ relative to planes 130, 132 parallel to the direction of travel 118. The heat shield centerline 38 is offset relative to the direction of travel 118 by an angle δ equal to the sum of: (i) the angle of attack α between the main body centerline 36 and the high enthalpy flow 126; and (ii) the angle β at which the heat shield centerline 38 is offset relative to the main body centerline 36. The angle of attack α should not exceed the sidewall angle θ. Maintaining the angle of attack α below this threshold prevents the high enthalpy flow 126 from impinging on the sidewall 28 of the vehicle 10, eliminating the need for additional heat shielding (and the accompanying additional mass) on those surfaces the sidewall 28. The baseline center of gravity 120 and the center of pressure 122 of the vehicle 10 can be selected to achieve a particular non-zero baseline trim angle of attack during atmospheric reentry.

In the illustrated embodiment, the skewed nature of the heat shield 14 (e.g., the oblique angle β of the heat shield outer surface relative to the main body centerline 36) allows the vehicle 10 to achieve a higher lift-to-drag ratio within a certain angle of attack constraint. That is, the vehicle 10 can achieve a certain target lift-to-drag ratio with a lower range of angles of attack α. This allows a shallower sidewall angle θ while still preventing hypersonic flow from impinging on the sidewall 28 of the vehicle 10. This in turn allows for increased volume available for other system uses (e.g., propellant, payload, etc.). As discussed above, in other embodiments not shown in the drawings, the vehicle 10 has an axisymmetric shape. In such embodiments, the heat shield centerline 38 is aligned with the main body centerline 36, and thus the heat shield 14 is not skewed.

In the illustrated embodiment, to minimize the additional mass of the heat shield 14 and aerodynamic controls, the vehicle 10 exposes only the relatively small heat shield 14 of the vehicle 10 to the high enthalpy flow 126, while also generating a sufficient lift-to-drag ratio for precise maneuvering and landing. By adjusting both the angle β of the heat shield outer surface relative to the main body centerline 36, and the location of the center of gravity 120, the design of the vehicle 10 can be adjusted to produce different amounts of lift while maintaining the same trimmed angle of attack. This adds freedom in the design space which is not available for traditional axisymmetric vehicle shapes. The combined surfaces of the heat shield 14 and nozzle 46 are advantageous in that they result in a lower mass penalty for the heat shield 14 in a reusable upper stage application.

Referring to FIG. 13, a method for reentering the atmosphere using the vehicle 10 includes the steps of: operating the vehicle 10 in space (step 134); maneuvering the vehicle 10 such that the vehicle 10 commences an atmospheric reentry phase of a flight trajectory (step 136); and travelling in the atmospheric reentry phase of the flight trajectory (step 138). The step of travelling in the atmospheric reentry phase of the flight trajectory includes: maintaining the vehicle 10 in an orientation in which the heat shield 14 defines the windward side of the vehicle 10 (step 140); actively cooling the heat shield 14 by transferring energy from the heat shield 14 to the coolant in the heat exchanger 16 to generate a heated fluid flow (step 142); and controlling an attitude of the vehicle 10 using at least a portion of the heated fluid flow (step 144). In embodiments in which the vehicle 10 is an upper stage rocket of a multi-stage rocket system 12, the method further includes, before the maneuvering step (step 136), launching the multi-stage rocket system 12 from sea level (step 146), and separating the vehicle 10 from at least one lower stage rocket 20 of the multi-stage rocket system 12 (step 148).

In some embodiments, the step of operating the vehicle 10 in space (step 134) includes capturing and storing a downmass payload in a payload housing 30 of the vehicle 10 (step 150). In some such embodiments, the payload housing 30 can be transitioned between a closed state, in which an internal payload cavity is enclosed and hermetically sealed by the payload housing 30, and an open state, in which the internal payload cavity is open to the ambient environment (e.g., space). The downmass payload can be captured by the vehicle 10 when the payload housing 30 is in the open state, and the payload housing 30 can be transitioned to the closed state for storage of the downmass payload before atmospheric reentry. In some embodiments, the vehicle 10 additionally or alternatively includes a payload (sometimes referred to hereinafter as a “hosted payload”) that is stored in the payload housing 30 during the ascent phase of the flight trajectory and that remains stored in the payload housing 30 (e.g., in a same or different form) during the atmospheric reentry phase of the flight trajectory.

As discussed above, in some embodiments, the vehicle 10 is configured such that it has a baseline center of gravity 120 and is configured to naturally adopt the baseline trim angle of attack when travelling in a ballistic trajectory. FIG. 5, for example, illustrates the vehicle 10 after it has naturally adopted an angle of attack α that is the baseline trim angle of attack.

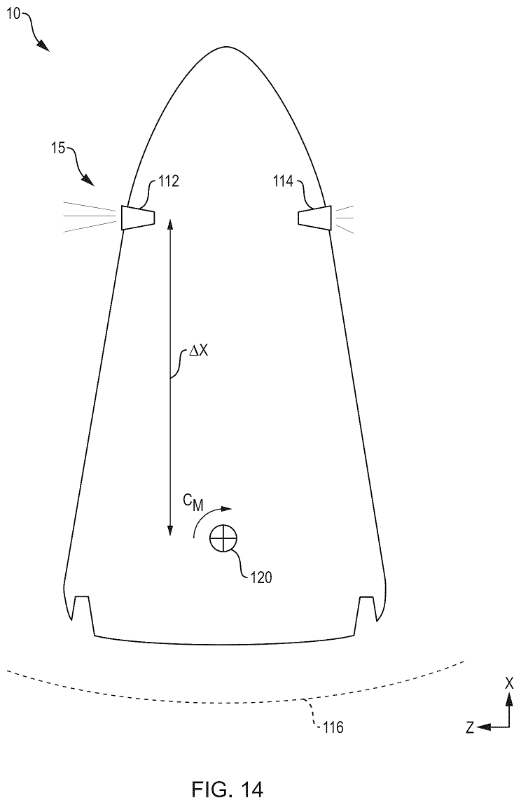

Referring to FIG. 14, in some embodiments, the step of controlling the attitude of the vehicle 10 (step 144) includes exhausting the bypass portion of the heated fluid flow from the one or more attitude control thrusters 112, 114 of the reaction control system 15 to generate a thrust (e.g., a non-symmetric thrust, a symmetric thrust) that induces a pitching moment C_{M} on the vehicle 10 and orients the vehicle 10 at a biased trim angle of attack (e.g., a predetermined trim angle of attack that is greater than or less than the baseline trim angle of attack). In the illustrated embodiment, the pitching moment C_{M} is equal to the product of the thrust generated by the attitude control thrusters 112, 114 and the axial distance ΔX between the attitude control thrusters 112, 114 and the center of gravity 120. In some embodiments, the vehicle 10 has a first lift-to-drag ratio when oriented at the baseline trim angle of attack and a second lift-to-drag ratio when oriented at the biased trim angle of attack, and the second lift-to-drag ratio is different than (e.g., greater than, less than) the first lift-to-drag ratio.

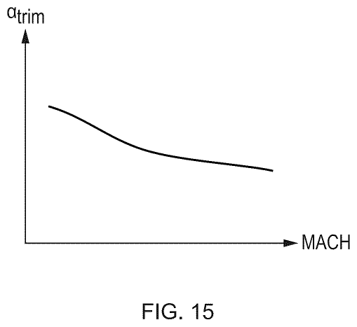

In some embodiments, the baseline trim angle of attack varies as a function of the velocity of the vehicle 10, as shown in FIG. 15. In some such embodiments, the reaction control system 15 is configured to maintain the biased trim angle of attack at a fixed magnitude across a range of velocities. In other embodiments, the reaction control system 15 is configured to change the biased trim angle of attack across the range of velocities (e.g., to maintain a constant bias relative to the baseline trim angle of attack).

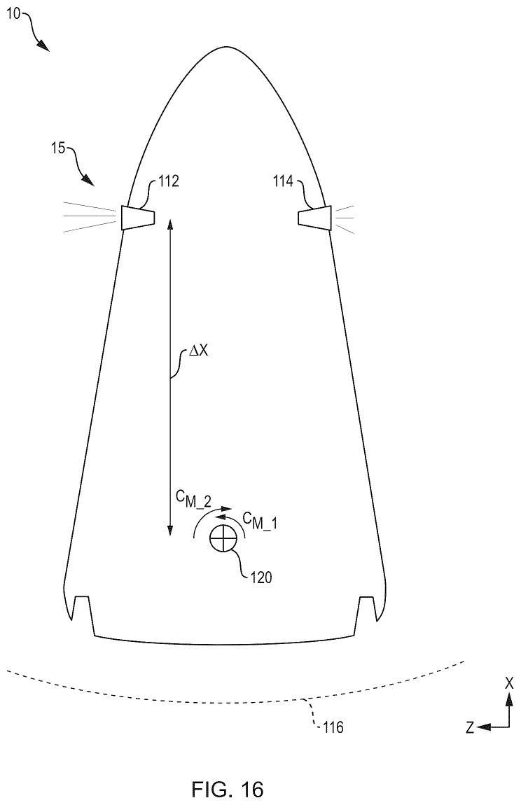

Referring to FIG. 16, in some embodiments, the storage of a payload (e.g., a downmass payload, a hosted payload) in the payload housing 30 of the vehicle 10 during the atmospheric reentry phase of the flight trajectory causes the vehicle 10 to have an offset center of gravity 120 (e.g., a center of gravity that is offset relative to the baseline center of gravity) that induces a first pitching moment C_{M_1} on the vehicle 10 and in turn causes the vehicle 10 to adopt an offset trim angle of attack (e.g., a trim angle that is offset relative to the baseline trim angle) when travelling in a ballistic trajectory. In some such embodiments, the step of controlling the attitude of the vehicle 10 (step 144) includes exhausting the bypass portion of the heated fluid flow from the attitude control thrusters 112, 114 of the reaction control system 15 to generate a thrust (e.g., a non-symmetric thrust, a symmetric thrust) that induces a second pitching moment C_{M_2} on the vehicle 10 and orients the vehicle 10 at a biased trim angle of attack. The second pitching moment C_{M_2} is equal to the product of the thrust generated by the attitude control thrusters 112, 114 and the axial distance ΔX between the attitude control thrusters 112, 114 and the offset center of gravity 120. In some embodiments, the second pitching moment C_{M_2} at least partially counteracts the first pitching moment C_{M_1}. In some embodiments, the biased trim angle of attack has a magnitude that is at least substantially the same as the magnitude of the baseline trim angle of attack. In other embodiments, the biased trim angle of attack has a magnitude that is different than (e.g., greater than, less than) the respective magnitudes of the baseline trim angle of attack and the offset trim angle of attack.

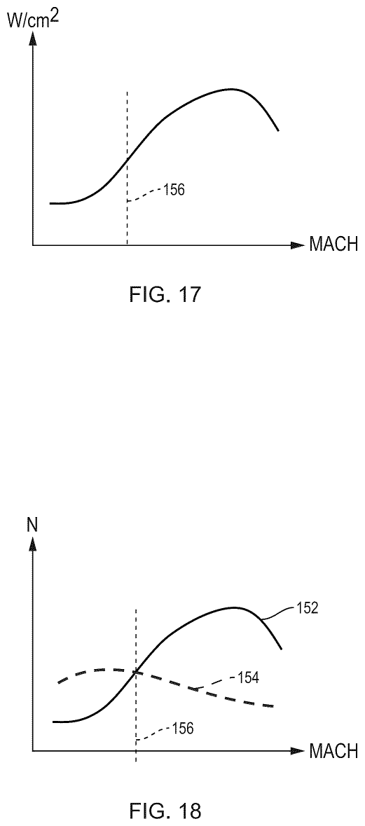

Referring to FIGS. 17 and 18, a magnitude of heat flux (W/cm2) through the heat shield 14 varies as a function of the velocity of the vehicle 10 (see FIG. 18), and the bypass portion of the heated fluid flow has an available impulse that is directly correlated to the magnitude of the heat flux (see solid line 152 in FIG. 18). The atmospheric reentry phase of the flight trajectory includes a high heat period during which a velocity of the vehicle 10 is above a threshold velocity 156 and the heat flux through the heat shield 14 is relatively high, and a subsequent low heat period during which the velocity of the vehicle 10 is below the threshold velocity 156 and the heat flux through the heat shield 14 is relatively low. In some embodiments, the threshold velocity 156 is a velocity in a range from Mach 4 to Mach 30. In other embodiments, the threshold velocity 156 is below Mach 4.

In some embodiments, the step of controlling the attitude of the vehicle 10 (step 144) includes using the bypass portion of the heated fluid flow to maintain the orientation of the vehicle 10 at the biased trim angle of attack during an entirety of the high heat portion of the atmospheric reentry phase. Referring to FIG. 18, in some such embodiments, the high heat portion of the atmospheric reentry phase corresponds to a period when the available impulse of the bypass portion of the heated fluid flow (solid line 152) exceeds an impulse required by the reaction control system 15 to overcome aerodynamic forces acting on the vehicle 10 (dashed line 154). In some embodiments, the step of controlling the attitude of the vehicle 10 (step 144) includes using the bypass portion of the heated fluid flow to orient the vehicle 10 at a first biased trim angle of attack during travel in the high heat period of the atmospheric reentry phase, and using the bypass portion of the heated fluid flow to orient the vehicle 10 at a second biased trim angle of attack during travel in the low heat period of the atmospheric reentry phase. These configurations may be prompted by the fact that, as the altitude of the vehicle 10 decreases during the atmospheric reentry phase, the vehicle 10 slows down and is subject to larger aerodynamic forces and higher ambient pressure. Also, there is less heat flux through the heat shield 14, which results in lower available impulse. At Mach numbers above the threshold velocity 156, the reaction control system 15 is configured to bias the trim angle of attack by inducing additional force and moment on the vehicle 10. At the high Mach numbers, there is sufficient available impulse due to the high heat flux to achieve a fully biased trim angle of attack. However, below a certain Mach number (e.g., below the threshold velocity 156), the reaction control system 15 is only able to achieve a partially biased trim angle of attack.

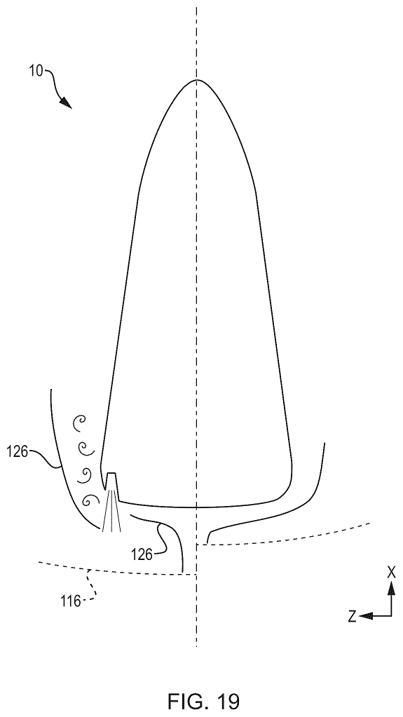

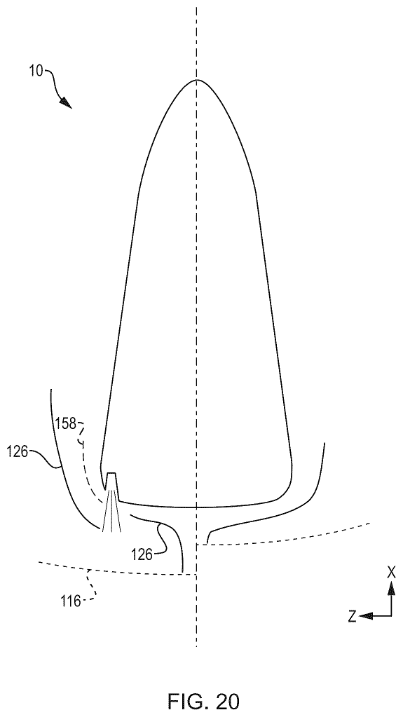

In some embodiments, the method further includes reducing a magnitude of heat flux through the heat shield 14 using a second bypass portion of the heated fluid flow. In some embodiments, this step is performed during travel in the atmospheric reentry phase of the flight trajectory (step 138) when the propulsion engine 18 is in the off mode (see FIGS. 10 and 11). In some embodiments, this step involves receiving the second bypass portion of the heated fluid flow in the combustion chamber 44 via the combustion chamber conduit 78 (see FIGS. 10 and 11) and exhausting the second bypass portion of the heated fluid flow through the nozzle 46 to at least one of: (i) push a bow shock 116 away from the vehicle 10 (see FIGS. 19 and 20); (ii) cause separation of a high enthalpy flow 126 from the base and/or sidewall of the vehicle 10 (see FIGS. 19 and 20); and (iii) provide a cooling film 158 on the outer surface of the vehicle 10 (see FIG. 20).

In some embodiments, the method additionally or alternatively includes reducing a magnitude of heat flux through the heat shield 14 by exhausting the turbine exhaust flow through one or more of the turbine exhaust ports 66. In some embodiments, this step is performed during travel in the atmospheric reentry phase of the flight trajectory (step 138) when the propulsion engine 18 is in the off mode (see FIGS. 10 and 11). In some embodiments, this step involves exhausting the turbine exhaust flow through one or more of the turbine exhaust ports 66 to at least one of: (i) push a bow shock 116 away from the vehicle 10 (see FIGS. 19 and 20); (ii) cause separation of a high enthalpy flow 126 from the base and/or sidewall of the vehicle 10 (see FIGS. 19 and 20); and (iii) provide a cooling film 158 on the outer surface of the vehicle 10 (see FIG. 20).

While several embodiments have been disclosed, it will be apparent to those having ordinary skill in the art that aspects of the present invention include many more embodiments. Accordingly, aspects of the present invention are not to be restricted except in light of the attached claims and their equivalents. It will also be apparent to those of ordinary skill in the art that variations and modifications can be made without departing from the true scope of the present disclosure. For example, in some instances, one or more features disclosed in connection with one embodiment can be used alone or in combination with one or more features of one or more other embodiments.

1. A vehicle, comprising:
a heat shield configured to define a windward side of the vehicle during travel in an atmospheric reentry phase of a flight trajectory;
a heat exchanger disposed relative to the heat shield and having a coolant therein, the heat exchanger configured to transfer energy from the heat shield to the coolant to generate a heated fluid flow; and
a reaction control system configured to adjust an attitude of the vehicle using at least a portion of the heated fluid flow.

2. The vehicle of claim 1, further comprising:
a nose;
a base opposite the nose;
a sidewall extending in a direction between the nose and the base;
a propulsion engine at the base;
wherein the heat shield is at the base; and
wherein the reaction control system is at the sidewall.

3. The vehicle of claim 2, wherein the reaction control system includes at least a first attitude control thruster at a first sidewall position and a second attitude control thruster at a second sidewall position.

4. The vehicle of claim 3, wherein the reaction control system includes a plurality of attitude control thrusters; and
wherein each of the plurality of attitude control thrusters is recessed into the sidewall of the vehicle.

5. The vehicle of claim 1, further comprising:
a flow controller configured to receive the heated fluid flow from the heat exchanger and control flow of at least the portion of the heated fluid flow to the reaction control system.

6-7. (canceled)

8. The vehicle of claim 5, further comprising:
a heated fluid conduit that fluidly connects the flow controller to the reaction control system, the heated fluid conduit configured to receive at least the portion of the heated fluid flow.

9. The vehicle of claim 8, wherein the flow controller is transitionable between a first state and a second state;
wherein in the first state, the flow controller is configured such that a flow path between the heat exchanger and the heated fluid conduit is closed; and
wherein in the second state, the flow controller is configured such that the flow path between the heat exchanger and the heated fluid conduit is open.

10. The vehicle of claim 9, further comprising:
a propulsion engine having a combustion chamber; and
a combustion chamber conduit that fluidly connects the flow controller to the combustion chamber of the propulsion engine.

11-12. (canceled)

13. The vehicle of claim 10, further comprising a flight controller configured to transition the flow controller between the first state and the second state at predetermined times during a flight trajectory of the vehicle.

14-15. (canceled)

16. The vehicle of claim 13, wherein the propulsion engine further includes a nozzle;
wherein the propulsion engine is transitionable between an on mode and an off mode;
wherein in the on mode of the propulsion engine, a second portion of the heated fluid flow and an oxidizer flow are combusted in the combustion chamber and a resulting combustion gas flow is exhausted through the nozzle;
wherein in the off mode of the propulsion engine, no combustion occurs within the combustion chamber.

17-19. (canceled)

20. The vehicle of claim 1, wherein the vehicle is an upper stage rocket of a multi-stage rocket system.

21. A multi-stage rocket system, comprising:
a lower stage rocket;
an upper stage rocket separable from the lower stage rocket, the upper stage rocket including:
a heat shield configured to define a windward side of the upper stage rocket during travel in an atmospheric reentry phase of a flight trajectory;
a heat exchanger disposed relative to the heat shield and having a coolant therein, the heat exchanger configured to transfer energy from the heat shield to the coolant to generate a heated fluid flow; and
a reaction control system configured to adjust an attitude of the upper stage rocket using at least a portion of the heated fluid flow.

22. The multi-stage rocket system of claim 21, wherein the upper stage rocket further includes:
a nose;
a base opposite the nose;
a sidewall extending in a direction between the nose and the base;
a propulsion engine;
wherein the propulsion engine and the heat shield are at the base; and
wherein the reaction control system is at the sidewall.

23. The multi-stage rocket system of claim 22, wherein the reaction control system includes at least a first attitude control thruster at a first sidewall position and a second attitude control thruster at a second sidewall position.

24. The multi-stage rocket system of claim 23, wherein the reaction control system includes a plurality of attitude control thrusters; and
wherein each of the plurality of attitude control thrusters is recessed into the sidewall of the upper stage rocket.

25. The multi-stage rocket system of claim 21, wherein the upper stage rocket further includes:
a flow controller configured to receive the heated fluid flow from the heat exchanger and control flow of at least the portion of the heated fluid flow to the reaction control system.

26. The multi-stage rocket system of claim 25, wherein the flow controller is a multi-port valve.

27. The multi-stage rocket system of claim 25, wherein the flow controller includes a plurality of discrete valves.

28. The multi-stage rocket system of claim 25, wherein the upper stage rocket further includes:
a heated fluid conduit that fluidly connects the flow controller to the reaction control system, the heated fluid conduit configured to receive at least the portion of the heated fluid flow.

29. The multi-stage rocket system of claim 28, wherein the flow controller is transitionable between a first state and a second state;
wherein in the first state, the flow controller is configured such that a flow path between the heat exchanger and the heated fluid conduit is closed; and
wherein in the second state, the flow controller is configured such that the flow path between the heat exchanger and the heated fluid conduit is open.

30. The multi-stage rocket system of claim 29, wherein the upper stage rocket further includes:
a propulsion engine having a combustion chamber; and
a combustion chamber conduit that fluidly connects the flow controller to the combustion chamber of the propulsion engine.

31. The multi-stage rocket system of claim 30, wherein the flow controller is configured such that, in both the first state and the second state, a third flow path between the heat exchanger and the combustion chamber conduit is open.

32. The multi-stage rocket system of claim 30, wherein the flow controller is configured such that, when the flow controller is in the first state, a flow path between the heat exchanger and the combustion chamber conduit is open, and when the flow controller is in the second state, the flow path between the heat exchanger and the combustion chamber conduit is closed.

33. The multi-stage rocket system of claim 30, wherein the upper stage rocket further includes a flight controller configured to transition the flow controller between the first state and the second state at predetermined times during a flight trajectory of the upper stage rocket.

34. The multi-stage rocket system of claim 33, wherein the flight controller is configured to transition the flow controller from the first state to the second state during a first predetermined period after an ascent phase of the flight trajectory and before an atmospheric reentry phase of the flight trajectory.

35. The multi-stage rocket system of claim 34, wherein the flight controller is configured to transition the flow controller from the second state back to the first state during a second predetermined period after the atmospheric reentry phase of the flight trajectory and before a landing phase of the flight trajectory.

36. The multi-stage rocket system of claim 33, wherein the propulsion engine further includes a nozzle;
wherein the propulsion engine is transitionable between an on mode and an off mode;
wherein in the on mode of the propulsion engine, a second portion of the heated fluid flow and an oxidizer flow are combusted in the combustion chamber and a resulting combustion gas flow is exhausted through the nozzle;
wherein in the off mode of the propulsion engine, no combustion occurs within the combustion chamber.

37. The multi-stage rocket system of claim 36, wherein the flight controller is further configured to transition the propulsion engine between the on mode and the off mode; and
wherein the flight controller is configured to maintain the flow controller in the first state when the propulsion engine is in the on mode, and maintain the flow controller in the second state when the propulsion engine is in the off mode.

38. The multi-stage rocket system of claim 36, wherein the second portion of the heated fluid flow is received in the combustion chamber via a combustion chamber conduit that fluidly connects the combustion chamber to the flow controller.

39. The multi-stage rocket system of claim 36, wherein in the off mode of the propulsion engine, the second portion of the heated fluid flow is received in the combustion chamber and is exhausted through the nozzle without being combusted.

40-62. (canceled)
